(19) United States
(12) Patent Application Publication
(10) Pub. No.: US 2007/0012490 A1
(43) Pub. Date: Jan. 18, 2007

(54) Electromagnetic radiation input for user interface

(75) Inventors: Hong W. Wong, Portland, OR (US); Wah Yiu Kwong, Beaverton, OR (US)

Correspondence Address: SCHWABE, WILLIAMSON & WYATT, PACWEST CENTER, SUITE 1900, 1211 S.W. FIFTH AVE., PORTLAND, OR, 97204, US

(73) Assignee: Intel Corporation

(21) Appl. No.: 11/170,617

(22) Filed: Jun. 28, 2005

(51) Int. Cl. G06F 3/033

(52) U.S. Cl. 178/19.01

(57) ABSTRACT

Embodiments of apparatuses, methods, and systems for a user interface to receive electromagnetic radiation as input are generally described herein. Other embodiments may be described and claimed.

### FIELD

Embodiments of the present invention relate generally to the field of user interfaces, and more particularly to using electromagnetic radiation as input for such user interfaces.

### BACKGROUND

User interfaces may have a wide variety of input mechanisms. One type of user interface may allow for input directly onto the screen. These user interfaces are often referred to as digitizers. Digitizers are devices that sense and convert a position of an input device on a screen surface into digital coordinate data. Prior art digitizers locate the position of the input device by using ultrasonic sensing devices, electromagnetic field location sensing devices, restive sensing devices, or capacitive sensing devices. Each of these prior art digitizers may present challenges such as imprecise tracking, electromagnetic interference, and/or the necessity of recalibration.

### BRIEF DESCRIPTION OF THE DRAWINGS

Embodiments of the invention are illustrated by way of example and not by way of limitation in the figures of the accompanying drawings, in which like references indicate similar elements and in which:

FIG. 1 illustrates a user interface and input device in accordance with an embodiment of the present invention;

FIG. 2 illustrates a front view of a sensing device in accordance with an embodiment of the present invention;

FIG. 3 illustrates an intensity distribution of electromagnetic radiation over elements of the light modulating device in accordance with an embodiment of the present invention;

FIG. 4 illustrates a front view of a light modulating device in accordance with an embodiment of the present invention;

FIG. 5 illustrates a front view of the user interface and input device in accordance with an embodiment of the present invention;

FIG. 6 illustrates components of the user interface in accordance with an embodiment of the present invention;

FIG. 7 illustrates a front view of an element of the light modulating device in accordance with an embodiment of the present invention;

FIG. 8 illustrates a front view of an element of a color filter in accordance with an embodiment of the present invention;

FIG. 9 illustrates components of the user interface in accordance with another embodiment of the present invention; and

FIG. 10 illustrates a front view of an element of a combined modulating/color filter device in accordance with an embodiment of the present invention.

### DETAILED DESCRIPTION

Illustrative embodiments of the present invention may include a user interface capable of receiving electromagnetic radiation as input.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific devices and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments. In particular, a wide variety of optical components not specifically shown such as, but not limited to, prisms, mirrors, lenses, integrators, diffusers, and/or polarizers may be used as appropriate to fold, bend, or modify the electromagnetic radiation for the intended application.

Further, various operations will be described as multiple discrete operations, in turn, in a manner that is most helpful in understanding the present invention; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise.

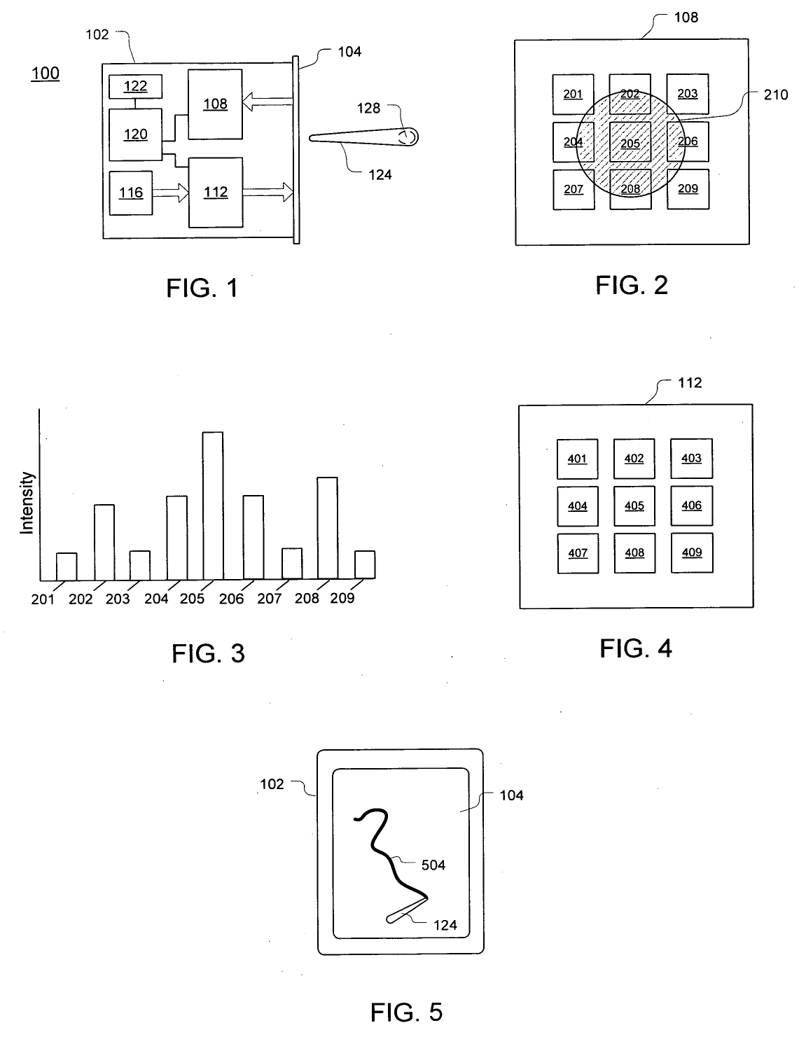

FIG. 1 illustrates a system 100 including a user interface 102 in accordance with an embodiment of the present invention. In this embodiment, the components of the user interface 102 may cooperate to render output of an image on a screen surface 104 and/or to sense provision of electromagnetic radiation at the screen surface 104. FIG. 1 introduces the components of the user interface 102 in order to facilitate the discussion of interactions between the components. FIG. 1 is not intended to necessarily present the physical layout of said components within the user interface 102. Physical layouts of various embodiments may be described below; however, other layouts are within the teachings of embodiments of the present invention.

In the present embodiment, a screen surface 104 may be optically coupled to both a sensing device 108 and a light modulating device 112, which are disposed on a first side of the screen surface 104, as shown. As used herein, “optically coupled” is intended to include the capability of electromagnetic radiation (EMR) to be directly or indirectly provided from one component to another. The light modulating device 112 may also be optically coupled to a light source 116, which may provide EMR, e.g., light, to the light modulating device 112.

In one embodiment the light source 116 may be, but is not limited to, a gaseous discharge lamp (e.g., high-pressure mercury, tungsten, halogen, or metal halide) and/or solid-state radiation sources (e.g., light-emitting diodes, laser diodes, etc.).

A processing device 120 may be coupled to the light modulating device 112 and configured to transmit control signals to the light modulating device 112. The control signals may cause matrix-addressable elements of the light modulating device 112 to modulate the light in a manner to output an image on the screen surface 104. Modulation of the light may be done by selectively transmitting portions of the light provided by the light source 116.

In one embodiment, the light modulating device 112 may include, e.g., a liquid crystal display. Examples of these types of displays include, but are not limited to, transmissive displays, such as thin film transistor (TFT), polysilicon (P-Si), and Silicon-on-insulator (SOI) as well as reflective displays such as LCoS (Liquid Crystal on Silicon). In other embodiments, the light modulating device 112 may additionally/alternatively employ other types of displays such as, but not limited to, a digital micromirror display (DMD), an organic light-emitting diode (OLED) display, which may also include the light source 116, etc.

In various embodiments, the processing device 120 may be a processor, an application-specific integrated circuit, a controller, etc. The processing device 120 may either be a resource dedicated to functions of the user interface 102 or shared with one or more other components of the system 100. Furthermore, in one embodiment the processing device 120 may include various processing sub-units to control the operation of various components of the user interface 102.

The processing device 120 may also be coupled to the sensing device 108. The sensing device 108 may be configured to receive and sense input in the form of EMR provided at the screen surface 104 from a second side of the screen surface 104 that is opposite the first side.

The processing device 120 may also be coupled to a storage medium 122. The storage medium 122 may store instructions that the processing device 120 may execute to cause one or more components of the user interface 102 to perform various functions. In various embodiments, the storage medium 122 may include, but is not limited to, read-only memory (ROM); random-access memory (RAM); magnetic disk storage media; optical storage media (e.g., Digital Versatile Disk, Compact Disk); and flash memory devices (e.g., USB flash drive, Secure Digital (SD) memory card, Compact Flash (CF) memory card, Smart Media (SM) memory card, Multi Media Card (MMC), MemoryStick (MS) card).

In one embodiment, EMR may be provided at the screen surface 104 by an input device 124: Use of EMR as input may facilitate the reduction of certain interference challenges such as electromagnetic interference. The input device 124 may have a radiation source 128 such as, but not limited to, a gaseous discharge lamp (e.g., high-pressure mercury, tungsten, halogen, metal halide, etc.) and/or solid-state radiation sources (e.g., light-emitting diodes, laser diodes, etc.).

In various embodiments, the user interface 102 may be, but is not limited to, a general-purpose computing device (e.g., a desktop computing device, a laptop computing device, a palm-sized computing device) or a peripheral computing device (e.g., a graphics tablet). In various embodiments, the user interface 102 may be employed in applications for use in medical imaging, military procedures, graphics editing, general computer input, etc.

FIG. 2 illustrates a front view of the sensing device 108 in accordance with an embodiment of the present invention. The sensing device 108 may have a number of elements, e.g., sensing elements 201-209, capable of sensing EMR at a given area and generating an electronic signal in response. Although FIG. 2 illustrates a 3×3 array of sensing elements, other embodiments may have any other sized array, which may or may not be symmetrical or even rectangular.

Each of these sensing elements 201-209 may correspond to a different area of the screen surface 104. An EMR pattern 210 provided from the input device 124 at the screen surface may be incident upon the one or more of the sensing elements 201-209 that correspond to the area the input device 124 is located. Because each of the sensing elements 201-209 correspond to a known area of the screen surface 104, recalibration, as required by prior art digitizers, is not necessary.

FIG. 3 illustrates a histogram of the intensities of the EMR at the sensing elements 201-209 in accordance with an embodiment of the present invention. In this embodiment, the sensing elements 201-209 may each send an electronic signal to the processing device 120 corresponding to the intensity of the EMR received at that element. The electronic signal sent to the processing device 120 from the sensing element 205 may reflect that it has received the greatest portion of EMR. Therefore, the processing device 120 may interpret this to mean that the input was centered at the area of the screen surface 104 corresponding to the sensing element 205.

Various signal processing techniques may be used in the processing of the electronic signals received from the sensing elements 201-209 depending on the objectives of a particular embodiment. In one embodiment radiative noise cancellation techniques may be used to account for ambient EMR by developing, e.g., a threshold intensity level.

Furthermore, the processing of the electronic signals received from the sensing elements 201-209 may be done in reference to the state of other components of the user interface 102. For example, in one embodiment, each of the sensing elements 201-209 may be optically coupled to receive the input EMR through a corresponding light modulating element. If a modulating element is transmitting only a relatively small amount of radiation, an electronic signal from a sensing element corresponding to that particular modulating element may be processed by taking this into account, e.g., by reducing a threshold intensity level.

In one embodiment, the input received by the sensing elements 201-209 may be synchronized with the image that is output on the screen surface 104 at the time of reception. For example, in one embodiment, the image output on the screen surface 104 may provide an input location, e.g., a dialog box having an “OK” button. If a sensing element senses the provision of EMR at that input location, the electronic signal transmitted to the processing device 120 may be interpreted by the processing device 120 to indicate a selection of that particular input command.

FIG. 4 illustrates a front view of the light modulating device 112 in accordance with an embodiment of the present invention. In this embodiment, the light modulating device may have a number of elements, e.g., modulating elements 401-409, capable of selectively transmitting portions of the light provided by the light source 116. In this embodiment the modulating elements 401-409 may respectively correspond to the sensing elements 201-209 in a 1:1 manner, which may, in turn facilitate having a sensing resolution commensurate with display resolution, e.g., a 1 dot resolution. Other embodiments may have other degrees of correspondence between sensing elements and light modulating elements, e.g., 1:n or n:1. The degrees of correspondence may be a factor of specific design implementations factoring in, e.g., market requirements and/or cost.

In this embodiment, the processing device 120 may receive an electronic signal from the sensing elements 201-209 as input and may generate and transmit, in response, control signals to the light modulating device 112 to activate corresponding modulating elements 401-409. In this manner, an image output on the screen surface 104 may provide visual feedback, to a user, of the input provided by the input device 124.

In various embodiments, the modulating elements 401-409 may create a visual representation of the EMR pattern 210 input to the sensing elements 201-209 in a number of ways. For example, in one embodiment, only the modulating element 405 corresponding to the sensing element 205 that receives the greatest amount of EMR may be activated. In another embodiment, the amount of light transmitted by each modulating element 401-409 may be proportional to the intensity of the EMR (over the threshold noise level) received at corresponding ones of the sensing elements 201-209. For example, in the above embodiment the modulating element 405 may transmit a first amount of light with each of the rest of the modulating elements 401-404 and 406-409 transmitting a reduced amount that is proportional to the reduced intensity on corresponding sensing elements 201-204 and 206-209.

In one embodiment, the light modulating device 112 may be manufactured separately from the sensing device 108 and coupled to one another post-manufacturing. In other embodiments, the light modulating device 112 may be integrally formed with the sensing device 108. Whether these components are separately or integrally formed may relate to a number of factors of particular embodiments including, e.g., temperatures involved in the deposition of elements, etc.

In various embodiments, the design of the light modulating device 112 and/or the sensing device 108 may facilitate incorporation into other types of computing devices, which could reduce manufacturing costs. For example, the light modulating device 112 may be designed such that the same device could be used in the user interface 102 as well as in a display not having the same input functionalities as the user interface 102, e.g., a display not having the sensing device 108.

FIG. 5 illustrates a front view of the user interface 102 in accordance with one embodiment of the present invention. As the input device 124 is moved over the face of the screen surface 104 the user interface 102 may sense the movement and output an image including a line 504 that serves as a visual indicator of the input received. In various drawing applications, it may be desirable to change attributes of the line, e.g., thickness. Therefore, in an embodiment the input parameters, e.g., the intensity and/or pattern of the EMR provided at the screen surface 104, may be adapted to effectuate the desired input. In one embodiment, the dynamic adjustment of the provided EMR may be through, e.g., squeezing the input device 124, to adjust the intensity and/or pattern of emitted EMR.

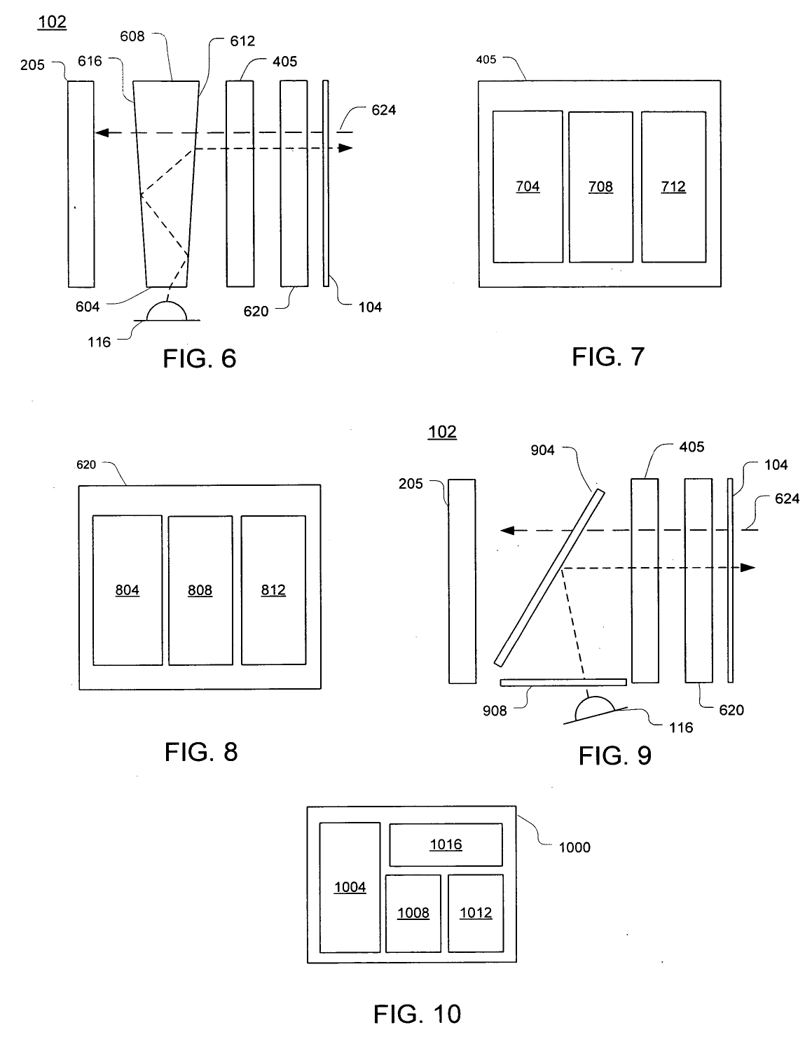

FIG. 6 illustrates a cross-sectional view of components of the user interface 102 in accordance with an embodiment of the present invention. In this embodiment the light source 116 may provide light into an end 604 of a light guide 608. The light guide 608 may direct the light out of a first surface 612 toward the modulating element 405. The light guide 608 may be tapered to facilitate gradual transmission of the light from the surface 612. Light hitting the surface 612 at an incident angle that is less than the critical angle may be transmitted, while light that is incident at an angle greater than the critical angle may experience total internal reflection. The internally reflected light may also experience total internal reflection at a second surface 616. In one embodiment, a coating may be applied to the second surface 616 to facilitate this internal reflection. Due to the taper of the light guide 608 the incident angle in which the light strikes the surface 612 may be incrementally decreased until it is less than the critical angle, at which point it may be transmitted to the modulating element 405, which may be a liquid crystal element in the present embodiment.

FIG. 7 illustrates a front view of the modulating element 405 in accordance with an embodiment of the present invention. The modulating element 405 may have a first section 704, a second section 708, and a third section 712. Each of these sections 704, 708, and 712 may be capable of selectively modulating light by transmitting selected amounts of the light. Referring also to FIG. 6, the light that is transmitted through the light modulating element 405 may be presented to a light filter element 620.

FIG. 8 illustrates a front view of the light filter element 620, in accordance with an embodiment of the present invention. The light filter element 620 may have sections 804, 808, and 812 that respectively correspond to the sections 704, 708, and 712 of the modulating element 405. In one embodiment, the filter section 804 may be configured to transmit light of a red spectrum, e.g., EMR having wavelengths approximately between 625-740 nanometers (nm), the filter section 808 may be configured to transmit light within a green spectrum, e.g., EMR having wavelengths of approximately 500-565 nm, and the filter section 812 may be configured to transmit light within a blue spectrum, e.g., EMR having wavelengths of approximately 440-485 nm. In various embodiments edge and/or notch filters may be used for the filtering out of undesired EMR.

In an embodiment where the filter section 804 is an edge filter, it may transmit EMR having wavelengths over 625 nm, which may include both the red spectrum and an infrared spectrum. Likewise, in an embodiment where the filter section 812 is an edge filter, it may transmit EMR having wavelengths under 485 nm, which may include the blue spectrum and an ultraviolet spectrum.

In one embodiment, the input device 124 may provide EMR of a spectrum that may encompass one or more of the wavelengths transmittable through the filter sections 804, 808, and/or 812. Referring also to FIG. 6, in one embodiment the input device 124 may provide broad spectrum EMR 624, e.g., white light, at the screen surface 104. The EMR 624 may be transmitted through the screen surface 104 to the color filter 620. Different portions of the EMR 624 may be transmitted through the different filter sections 804, 808, and 812. The modulating element 405 may receive the different portions of the EMR 624 from the filter sections 804, 808, and 812 and modulate the EMR 624. The modulated EMR 624 may enter the light guide 608. Due to the angles at which the EMR 624 enters the light guide, at least a portion may be transmitted through to the sensing element 205.

In this embodiment, if all of the modulating sections 704, 708, and 712 happened to be closed, e.g., configured to transmit no light in either direction, the EMR 624 may be prevented from being transmitted through the modulating element 405. However, the instances of this happening may be rare enough, both in the frequency of occurrence and in the time that such an occurrence would last, that it may not have a noticeable impact on the consistent receipt of input. An embodiment may transmit a certain level of backlight even through the darkest modulating elements, such that EMR provided by the input device 124 may be transmitted through the modulating elements. Additionally, in various embodiments, radiative noise cancellation techniques may be adapted to accommodate darker modulating elements, e.g., the threshold level may be reduced.

In one embodiment, the EMR 624 may include non-visible EMR, e.g., radiation of the infrared spectrum. The infrared portion of the EMR 624 may be transmitted through the filter section 804 if it is, e.g., an edge filter that allows radiation of both the red spectrum and the infrared spectrum. The infrared EMR 624 may pass through the modulating element 405, through the light guide 608 and be incident upon the sensing element 205.

In one embodiment, a coating, e.g., a dichroic coating may be applied to a surface, e.g., the surface 616, of the light guide 608. The dichroic coating may transmit EMR within the IR spectrum while reflecting light with wavelengths that are below the IR spectrum. This may facilitate the internal reflection of the EMR provided by the light source 116, while allowing the IR portion of the EMR 624 to be transmitted to the sensing element 205. In an embodiment where the light source 116 emits broad spectrum EMR, steps may be taken to filter out the IR EMR prior to the internal reflections within the light guide 608. This may be done, e.g., by a filter coating on the end 604.

FIG. 9 illustrates components of the user interface 102 in accordance with another embodiment of the present invention. In this embodiment, a light guide 904 may be used to direct light provided by the light source 116 towards the modulating element 405, and to transmit EMR 624 from the input device 124 to the sensing element 205, similar to the light guide 608 illustrated and described above. However, in this embodiment, the light guide 904 may be a dichroic mirror configured to transmit certain wavelengths of EMR, e.g., over 740 nm, while reflecting other wavelengths, e.g., under 740 nm. This embodiment may allow for infrared portions of the EMR 624 to be incident upon the sensing element 205 while directing the non-infrared portions of EMR from the light source 116 towards the modulating element 405. In one embodiment, a filter 908 may be placed adjacent to the light source 116 to filter infrared portions of EMR so that the sensing element 205 does not inadvertently sense infrared EMR from the light source 116.

As shown in FIG. 7 and in FIG. 8, the sections configured for the various colored light may be approximately the same dimensions. However, in other embodiments one or more of the sections may have different dimensions. Furthermore, various embodiments may have more or less than the three sections shown above.

FIG. 10 illustrates a front view of a combined modulating/filtering element 1000 in accordance with an embodiment of the present invention. In this embodiment, a section 1004 may be configured for modulating/filtering EMR in the green spectrum, section 1008 may be configured for modulating/filtering EMR in the red spectrum, and section 1012 may be configured for modulating/filtering EMR in the blue spectrum. In this embodiment, there may be an additional section 1016 that may be configured for the transmitting of EMR provided by the input device 124.

In one embodiment, the section 1016 may have a filter to facilitate differentiation of the EMR provided from the input device 124 from ambient EMR. For example, the input device 124 may provide EMR within the infrared spectrum and the filter segment of section 1016 may filter out substantially all of the non-infrared EMR. In various embodiments, the section 1016 may or may not be capable of modulating the EMR provided by the input device 124.

An embodiment having the section 1016 transmit only non-visible radiation, e.g., IR EMR, may facilitate the filtering out of visible radiation from the light source 116. This may, in turn, facilitate the input of EMR from the input device 124 without adversely affecting the output of an image on the screen surface 104.

The varying dimensions of the sections of this embodiment may be based at least in part on a motivation to have more EMR of the green spectrum transmitted as output to facilitate a desired color balance. This embodiment may, therefore, use the area provided by the reduced dimensions of sections 1008 and 1012 for section 1016.

Although the present invention has been described in terms of the above-illustrated embodiments, it will be appreciated by those of ordinary skill in the art that a wide variety of alternate and/or equivalent implementations calculated to achieve the same purposes may be substituted for the specific embodiments shown and described without departing from the scope of the present invention. Those with skill in the art will readily appreciate that the present invention may be implemented in a very wide variety of embodiments. This description is intended to be regarded as illustrative instead of restrictive on embodiments of the present invention.

What is claimed is:

1. An apparatus comprising:
a sensing device to be disposed with a light modulating device on a first side of a screen surface, said light modulating device to modulate first electromagnetic radiation from the first side for rendering output on the screen surface, and said sensing device to sense provision of second electromagnetic radiation from a second side of the screen surface as input, the first and second sides of the screen surface being opposite sides.

2. The apparatus of claim 1, further comprising:
the light modulating device.

3. The apparatus of claim 2 further comprising:
the screen surface.

4. The apparatus of claim 3, wherein the sensing device is optically coupled to the light modulating device and the light modulating device is further configured to transmit the second electromagnetic radiation to the sensing device.

5. The apparatus of claim 4, further comprising:
a light source optically coupled to the light modulating device and configured to provide the first electromagnetic radiation.

6. The apparatus of claim 5, further comprising:
a light guide optically coupled to the light source and configured to receive the first electromagnetic radiation from the light source, to transmit at least a portion of the first electromagnetic radiation from the light source towards the light modulating device, to receive the second electromagnetic radiation from the light modulating device, and to transmit the second electromagnetic radiation towards the sensing device.

7. The apparatus of claim 6, wherein the light guide includes a dichroic coating on a first surface.

8. The apparatus of claim 2, wherein the first electromagnetic radiation includes radiation within a blue spectrum, a green spectrum, and a red spectrum.

9. The apparatus of claim 8, wherein the light modulating device comprises:
an element having a first section to modulate a first portion of the first electromagnetic radiation, a second section to modulate a second portion of the first electromagnetic radiation, and a third section to modulate a third portion of the first electromagnetic radiation.

10. The apparatus of claim 9, wherein the element of the light modulating device further comprises:
a fourth section optically coupled to the sensing device and configured to transmit the second electromagnetic radiation.

11. The apparatus of claim 9, wherein the digitizer further comprises:
a color filter having an element with a first section to transmit light within the blue spectrum, a second section to transmit light with the green spectrum, and a third section to transmit light within the red spectrum, the first, second, and third sections of the element of the color filter being optically coupled to the first, second, and third sections of the element of the light modulating device, respectively.

12. The apparatus of claim 9, wherein the second electromagnetic radiation includes radiation within an infrared spectrum.

13. The apparatus of claim 2, wherein the light modulating device includes a display selected from the group consisting of a liquid crystal display and an organic light emitting device display.

14. A method comprising:
modulating, with a light modulating device disposed on a first side of a screen surface, first electromagnetic radiation from the first side for rendering output on the screen surface; and
sensing, with a sensing device disposed on the first side of the screen surface, provision of second electromagnetic radiation from a second side of the screen surface as input, the first and second sides being opposite sides.

15. The method of claim 14, wherein said sensing of the provision of the second electromagnetic radiation further comprises:
transmitting, by the light modulating device, the second electromagnetic radiation to the sensing device.

16. The method of claim 15, wherein said modulating of the first electromagnetic radiation for output further comprises:
modulating, with a first area of an element of the light modulating device, the first electromagnetic radiation for output.

17. The method of claim 16, wherein said transmitting of the second electromagnetic radiation further comprises:
transmitting the second electromagnetic radiation through a second area of the element of the light modulating device.

18. The method of claim 14, further comprising:
providing, by a light source, the first electromagnetic radiation; and
directing, with a light guide, the first electromagnetic radiation from the light source to the light modulating device.

19. The method of claim 18, further comprising:
transmitting, by the light guide, the second electromagnetic radiation to the sensing device.

20. A system comprising:
a user interface including
a screen surface;
a light modulating device disposed on a first side of the screen surface and configured to modulate first electromagnetic radiation from the first side for rendering output on the screen surface; and
a sensing device disposed on the first side and configured to sense provision of second electromagnetic radiation from a second side of the screen surface as input, the first and second sides being opposite sides; and
an input device including a solid-state radiation source configured to provide the second electromagnetic radiation.

21. The system of claim 20, wherein the input device is further configured to adjust input parameters including an intensity and/or a pattern of the second electromagnetic radiation.

22. The system of claim 21, wherein the sensing device is further configured to produce an electronic signal based at least in part on the sensed second electromagnetic radiation, the system further comprising:
a processing device coupled to the sensing device and the light modulating device and configured to receive the electronic signal from the sensing device and to control the light modulating device based at least in part on the electronic signal.

23. The system of claim 20, wherein the light modulating device comprises a liquid crystal light modulating device.

24. A storage medium having instructions stored therein, which, when executed by a processing device, cause the processing device to
control a light modulating device disposed on a first side of a screen surface in a manner to modulate first electromagnetic radiation from the first side for rendering output on the screen surface; and
receive electronic signals from a sensing device disposed on the first side of the screen surface, indicating provision of second electromagnetic radiation from a second side of the screen surface as input, the first and second sides being opposite sides.

25. The storage medium of claim 24, wherein the instructions stored therein, which, when executed by the processing device, further cause the processing device to
receive electronic signals from a plurality of sensing elements of the sensing device; and
identify a location of the provision of the second electromagnetic radiation on the screen surface based at least in part on said received electronic signals from the plurality of sensing elements.

26. The storage medium of claim 25, wherein the instructions stored therein, which, when executed by the processing device, further cause the processing device to
render output on the screen surface, with a plurality of light modulating elements of the light modulating device, corresponding to the location of the provision of the second electromagnetic radiation.
